(19) United States
(12) Patent Application Publication
(10) Pub. No.: US 2016/0311003 A1
(43) Pub. Date: Oct. 27, 2016

(54) SOIL-TREATMENT SYSTEM, GEOCOMPOSITE FOR SUCH A SYSTEM, AND SOIL CONSOLIDATION METHOD

(71) Applicant: AFITEX INTERNATIONAL, Chartres (FR)

(72) Inventors: Yves DURKHEIM, LUISANT (FR); Sébastien Robert René BOURGES-GASTAUD, Vallauris Golfe-Juan (FR)

(73) Assignee: AFITEX INTERNATIONAL, CHARTRES (FR)

(21) Appl. No.: 15/102,745

(22) PCT Filed: Dec. 9, 2014
(86) PCT No.: PCT/EP2014/077094

§ 371 Date: Jun. 8, 2016

(30) Foreign Application Priority Data
Dec. 9, 2013 (FR) 1362297

(51) Int. Cl. B09C 1/08; C02F 11/00; C02F 11/12; E02D 3/11

(52) U.S. Cl. CPC B09C 1/085; E02D 3/11; C02F 11/006; C02F 11/12; C02F 2103/10

(57) ABSTRACT

The present invention concerns a soil-treatment method and system, comprising at least one electricity generator (10) and at least two electrodes (11, 12), as well as at least one pumping device (20), characterised in that the system comprises at least one geocomposite (2) that contains at least one portion of at least one of said electrodes (11, 12) and which includes at least one filtering layer (21) and/or at least one draining layer (22), and in that at least one portion of at least one of said electrodes (11, 12) comprises carbon.

### TECHNICAL FIELD OF THE INVENTION

The present invention relates to the field of soil treatment, particularly for the decontamination of soils or the dewatering of mud or mining tailings by electrokinetic phenomena. The present invention more particularly relates to a soil treatment system, allowing the dewatering of the soils, particularly mud or tailings (for example from mining), whatever the nature of the soil (mud or tailings.) This invention also relates to a geocomposite for such a system and also relates to a soil consolidation method. In the present application, the terms soil, mud or tailings are used interchangeably to denote the same entity although they are generally considered different, notably because of their organic, mineral or complex nature.

### TECHNOLOGICAL BACKGROUND OF THE INVENTION

One problem in the field of soil treatment, particularly the treatment of muds with high water content, is posed by their dewatering, which is generally difficult because of their low granularity, colloidal behavior and low hydraulic conductivity. These soils or materials can come, for example and without being limiting, from the purification of wastewater, mining (extractive) industries or the dredging of river-port sediments. Specifically, in all these various sectors, it is necessary to dewater the materials, particularly to allow their consolidation, necessary for the rehabilitation of the dedicated storage areas. For example, mining industries generally lead to an enormous production of mineral waste, often diluted in large quantities of water. When water is used to concentrate the useful ore, waste generally appears in the form of mud, pulp or tailings, which are basically solid waste particles dispersed in the water. In particular, but without being limiting, the exploitation of bituminous sands, phosphate or aluminum refining all generate mud with a very fine grain (D₈₀<20 μm) and a high clay content. This type of mud or tailings has low shear resistance, a liquid behavior and cannot be stored easily. The tailings are often diluted in large quantities of water and generally stored on the ground, in a dedicated basin, for example surrounded by embankments, for example built from the coarsest fraction of the tailings. These tailings basins are often very large installations which are known for being unstable, able to generate destructive mudslides, generally because of poor management of the water (inadequate draining, internal erosion, overflowing). To allow the rehabilitation of the tailings basins (e.g. increase the bearing capacity) and minimize the water consumption (avoid storage in the basins), the mud must be consolidated/dewatered. Dehydration (or dewatering) of materials with a high water content is therefore essential to reduce the environmental impact of certain industries, and in general to supply practical and economical solutions to these problems.

Mechanical dehydration solutions are known to the prior art such as filtration/compression, such as for example band filters or filter presses, often advantageous for their low cost and power consumption. However, for many applications this type of solution does not make it possible to reach a high enough percentage of solid content, particularly because the mud has a colloidal system having strong surface effects. Due to the strength of the forces bonding water to solid matter and the strong electrostatic forces between small particles, the mechanical forces to be applied are often too great for these solutions to allow a high enough solid content to be efficiently reached.

In addition, the water in mud or tailings is generally found in four main forms which are free water, interstitial water, pellicular water and combined water. Free water, also known as gravitational water, is not affected by capillary forces and can be removed by mechanical dewatering. Interstitial water kept in pore spaces by capillary forces does not react to gravity and only part of it can be removed by mechanical dehydration. Vicinal water, strongly bound to solid particles by adsorption in the electric double sheet, is composed of water molecules stratified on the surfaces of solids. Hydration water, chemically tightly bound to solid molecules, can only be extracted from mud by heating. Due to the high proportion of fine particles with a high specific surface (such as clay for example) in mud or tailings, the capillary forces exerted are very large and it is likely that a large part of the water will be pellicular water or interstitial water, requiring appropriate solutions.

Also known to the prior art in the field of soil treatment are solutions for draining liquids, such as for example geotextiles or, more advantageously, geocomposites, for example such as those described in the patent applications WO 2006/030076, WO2011015736 or WO2012/080659 comprising at least 2 sheets of geotextile and perforated mini-drains improving the evacuation of the fluids. This type of solution has the advantage of accelerating and improving dewatering, in particular because it can be provided with large dimensions to offer what are generally known as draining horizons. Indeed, drainage geocomposites can be inserted into the tailings basins in order to create a drainage sheet (horizon) providing conditions favorable to the tailings, by involving several mechanical phenomena which can lead to consolidation. This is because the drainage horizon in saturated tailings interrupts the hydrostatic pressure profile of the water. Thus, the water above the draining horizon is no longer carried by the water below the draining horizon, and thus the weight of the water contained above the horizon acts as an actual load on the material below the horizon. Thus, the effective stress applied to the lower sheets is increased, which leads to the consolidation of the lower sheets. Moreover, with a draining horizon, the fluid of the upper sheet tends to flow downward and this movement induces an infiltration force which also induces an increase in the effective stress and promotes consolidation.

Also known to the prior art are soil dewatering solutions using electrokinetic phenomena. These phenomena can have several aspects, such as electrophoresis (motion of ions in a solution under an electric field), electro-osmosis (motion of a liquid in a porous medium under an electric field), electrodialysis (motion of ions across a membrane under an electric field) or electromigration (motion of atoms under an electric field.) Electro-osmosis can be used in clay soils for example; water moves from the anode to the cathode under a DC electric field. The electrical double layer is responsible for this phenomenon: the clay has a negatively-charged surface and the cations are adsorbed into the electrical double layer at the surface of the clay. Under an electric field, the cations of the diffuse sheet are attracted to the cathode and draw the surrounding water along with them by viscomotor coupling, thus creating a net flow of water to the cathode. Consequently, these phenomena can be used in civil engineering to consolidate clay materials, which are particularly difficult to consolidate due to their very low hydraulic conductivity.

Taking advantage of these phenomena to dry out soils is also known, such as for example in the patent applications WO200158610 and WO200046450 wherein various systems and particularly geosynthetics incorporating electrodes are used to apply electrokinetic phenomena in the soils for the purpose of improving the dehydration. However these solutions, which have often only been approved on a small scale (in particular on the laboratory scale, or at best on surface areas in the order of a few meters or tens of meters, or square meters) generally have the drawback of not being suitable for implementation on large-scale sites, such as mining basins for example.

The problems related to large-size scales are specifically the volumes of water, the dimensions of the sites to be treated and evacuation. Solutions are known, such as application WO200039405 for example, which take advantage of the possibility of supplying large dimensions of geosynthetics wherein electrodes are arranged.

However, this type of solution still faces problems related to the nature of the soils, muds or tailings that can saturate the geosynthetic sheets and significantly corrode the various materials used, rendering this type of solution quickly unusable. A recurring problem of the application of electro-osmosis in the field specifically concerns the rapid corrosion of the anode. During treatment, the electrolysis of the water causes a drop in the pH near the anode (which can fall to 1 or 2), and additionally the electron flow to the anode causes the lysis of the metal, leading to its dissolution. This electrochemical corrosion is problematic whatever the metal used. Thus, despite the precious contribution made by electro-osmosis to the dehydrating of materials with low permeability, it is not widely used in geotechnical applications, particularly because of the short lifetime of the anode. Specifically, the corrosion induces a rapid decrease in the effectiveness of the treatment, ending in the total disappearance of the anode in a relatively short time (for example a single day.)

Methods for detecting leaks in soils using geotextiles containing electrodes are known to the prior art, particularly from the patent application EP0962754. However, this type of solution does not allow for soil consolidation. Moreover, soil consolidation systems using geotextiles and electrodes of various kinds are known to the prior art, particularly from the document “Dewatering of mine tailings using electrokinetic geosynthetics” by AB FOURIE et al. in “Canadian Geotechnical Journal”, vol. 44, no. 2, Feb. 1, 2007 (2007-02-01), pages 160-172, XP055146921, ISSN: 0008-367 4, DOI: 1 0.1139/t06-112. In particular, this document describes the ineffectiveness of certain carbon electrodes but describes the relative effectiveness and stability of electrodes comprising metal (stainless steel) surrounded by a resin containing carbon black. However, this type of solution has the drawback of requiring the complex and expensive manufacturing of a resin (of high-density polyethylene) containing carbon black and a wire surrounded by this resin. Worst of all, it has the drawback of still resulting in electrodes of limited stability, because, during use, the resin loses its plasticity because of the inclusion of carbon black and deteriorates quite rapidly (specifically splitting), thus exposing the metal to corrosion.

In this context, it is beneficial to propose a reliable and viable solution that offers the advantages of the prior art without suffering from their drawbacks, and which meets the known requirements.

### GENERAL DESCRIPTION OF THE INVENTION

The present invention has the aim of palliating at least some of the drawbacks of the prior art by proposing a soil treatment system, particularly for the decontamination of soil or the dewatering of mud or mining tailings by electrokinetic phenomena, which is reliable and viable, particularly on a large scale.

This aim is achieved by a soil treatment system, particularly for the decontamination of soil or the dewatering of mud or mining tailings by electrokinetic phenomena, comprising, firstly, at least one electric generator and at least two electrodes and, secondly, at least one evacuation device, characterized in that:
the system includes at least one geocomposite which incorporates at least a part of at least one of said electrodes and which comprises at least one filtering sheet and/or at least one draining sheet,
at least a part of at least one of said electrodes contains carbon, in the form of carbon fibers.

This aim is generally achieved by a soil treatment system comprising, firstly, at least one electric generator and at least two electrodes and, secondly, at least one evacuation device, characterized in that:
the system includes at least one geocomposite that contains at least a part of at least one of said electrodes and which comprises at least one filtering sheet and/or at least one draining sheet,
perforated mini-drains are incorporated into said geocomposite,
at least a part of at least one of said electrodes is disposed along a path substantially parallel to the mini-drains.

According to another peculiarity, at least a part of the two electrodes contains carbon.

According to an alternative, only one of the two electrodes has at least a part containing carbon whereas the other electrode is metallic.

According to another peculiarity, perforated mini-drains are incorporated into said geocomposite.

According to another peculiarity, the electrodes are disposed substantially parallel to the mini-drains.

According to another peculiarity, the electrodes are wound around the mini-drains of the geocomposite.

According to another peculiarity, said carbon of said electrodes is in the form of carbon fibers.

According to another peculiarity, the carbon fibers are sewn onto at least one sheet of the geocomposite.

According to another peculiarity, the two electrodes have at least a part incorporated into or onto separate strips of geocomposite disposed at a distance from one another within the soil to be treated.

According to another peculiarity, the system includes switching means to reverse the polarity of the electrodes.

According to another peculiarity, said electrodes, at least a part of which contains carbon, comprise at least one other part made of metal to improve the distribution of the current of the generator over long distances.

According to another peculiarity, said metal parts and their connections with the carbon parts are equipped with means for protecting from corrosion.

According to another peculiarity, the means for protecting from corrosion include watertight insulation means.

Another aim of the present invention is to palliate at least some of the drawbacks of the prior art by proposing a geocomposite for soil treatment, particularly for the decontamination of soil or the dewatering of mud or mining tailings by electrokinetic phenomena, which is reliable and viable, particularly on a large scale.

This aim is achieved by a soil treatment geocomposite, characterized in that it is arranged for use in a system according to the invention, at least by the fact that it incorporates at least a part of at least one of the electrodes of the system and that it comprises at least one filtering sheet and/or at least one draining sheet, at least a part of at least one of said electrodes containing carbon.

This aim is also achieved by a soil treatment geocomposite, characterized in that it is arranged for use in a system according to certain embodiments of the invention, at least by the fact that it comprises at least one filtering sheet and/or at least one draining sheet, with incorporated perforated mini-drains, and that it incorporates at least a part of at least one of the electrodes of the system, disposed along a path substantially parallel to the mini-drains.

Another aim of the present invention is to palliate at least some of the drawbacks of the prior art by proposing a method of soil treatment, particularly for the decontamination of soil or the dewatering of mud or mining tailings by electrokinetic phenomena, which is reliable and viable, particularly on a large scale.

This aim is achieved by a method for consolidating soil, particularly mud or tailings, by the use of a system according to the invention, in a consolidation basin, the method being characterized in that it includes:
laying of at least one geocomposite according to the invention in said basin;
connection of the geocomposite to the evacuation device;
connection of said at least one electrode of the geocomposite to said electric generator;
pouring of mud or tailings onto the geocomposite;
connection of the other electrode to said electric generator.

According to another peculiarity, the method includes the laying of a second geocomposite according to the invention in said basin and the step of connecting the other electrode to said electric generator corresponds to a connection of the electrode of this second geocomposite.

According to another peculiarity, the method includes a reversal of the polarity of the electrodes, using switching means, this reversal of polarity being implemented at the end of a determined period, to optimize the lifetime and/or effectiveness of the system.

### DESCRIPTION OF THE ILLUSTRATIVE FIGURES

Other peculiarities and advantages of the present invention will become more clearly apparent on reading the description hereinafter, given with reference to the appended drawings, wherein:

FIG. 1 represents a perspective view of a treatment system according to certain embodiments of the invention,

FIG. 2 represents a perspective view of a treatment system according to certain embodiments of the invention,

FIG. 3 represents a section view of a part of a treatment system, installed in the soil, according to certain embodiments of the invention,

FIGS. 4A and 4B represent a section view of a part of a treatment system, installed in the soil according to various embodiments of the invention,

FIGS. 5A, 5B and 5C represent perspective views of a treatment geocomposite according to various embodiments of the invention,

FIG. 6 represents a schematic diagram of a method according to certain embodiments of the invention.

### DESCRIPTION OF THE PREFERRED EMBODIMENTS OF THE INVENTION

The present invention relates to a system, a geocomposite and a method of soil treatment (S), in particular for the treatment of mud or mining tailings as detailed in the introduction. This mud or tailings (S) is generally poured into a basin (B) surrounded by earthworks (D) and equipped with evacuation means such as evacuation pipes (3) and at least one evacuation device (20).

System

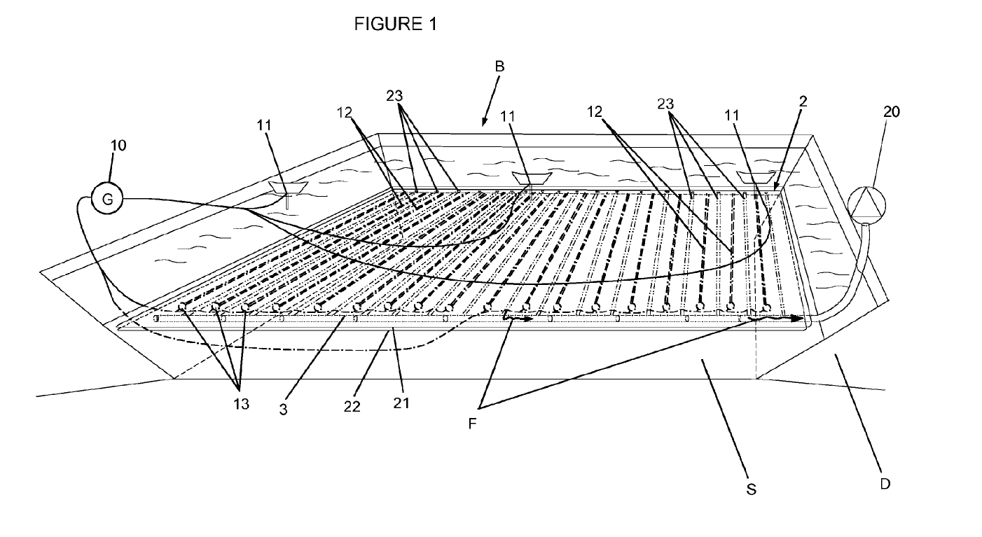

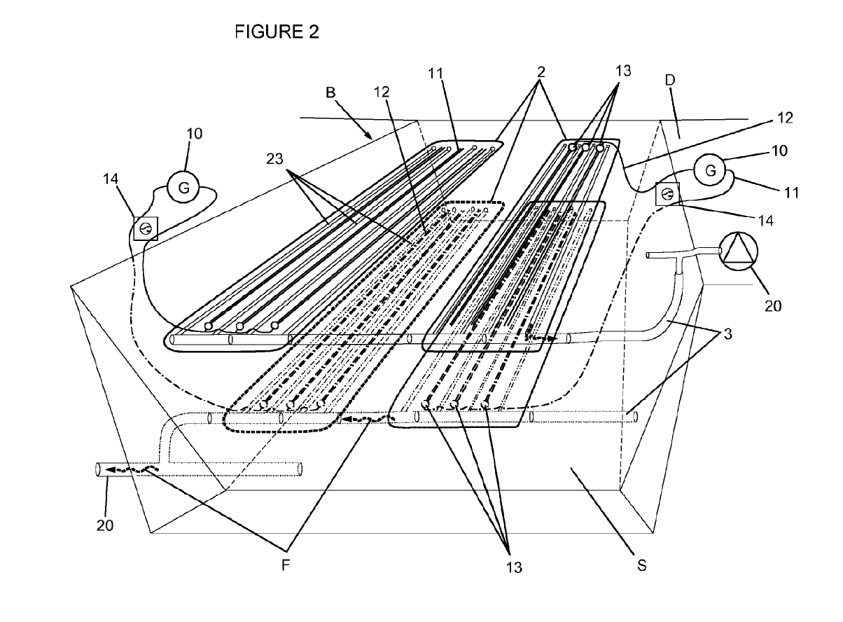

The soil treatment system, particularly advantageous for the decontamination of soils or the dewatering of mud or mining tailings by electrokinetic phenomena, comprises, firstly, at least one electric generator (10) and at least two electrodes (11, 12) and, secondly, at least one evacuation device (20). This evacuation device (20) is for evacuating the fluids (F), generally liquids, denoted here by the term “water” which is in fact used whether or not the water is still loaded with organic materials or minerals or other materials (it is specifically often a “diluted mud”.) This evacuation device (20) can for example include a pump, for example as represented in FIG. 1, but it can simply include an outlet, such as for example ducts formed in the basin to collect the water that flows out under gravity. This evacuation device can also include any combination of active and passive evacuations, as represented in FIG. 2 for example. Of course, the evacuation of the water (F) will generally be done using evacuation pipes (3) arranged in the basin (B) and linked to the evacuation device (20). The system according to the invention preferably includes at least one geocomposite (2) which incorporates at least a part of at least one of said electrodes (11, 12) and which comprises at least one filtering sheet (21) and/or at least one draining sheet (22). In addition, at least a part of at least one of said electrodes (11, 12) contains carbon.

Thus, this system, using the geocomposite which incorporates at least one electrode, makes it possible to apply the voltage/the current directly into the soil to be dried and provides an effective medium for draining waters (F) using the sheet(s), and preferably the mini-drains incorporated into the geocomposite in certain embodiments. The term “sheet” is used here to denote any type of geosynthetics in general, whether or not it is a geotextile, in particularly those used conventionally in soil dewatering applications. In addition, it is question here of at least one geocomposite and those skilled in the art will appreciate that it is in fact possible to have strips of geocomposite or several geocomposites, of variable sizes, as may be seen by comparing FIGS. 1 and 2, this term in fact not entailing any limitations on the forms and dimensions, with the exception of the fact that it makes it possible to cover large surface areas such as those of the tailings basins. Similarly, it is question here of at least two electrodes (11, 12) and particularly at least one cathode and at least one anode. However, as the industrial application of the invention generally relate to areas of large dimensions, it is generally preferable to use a large number of electrodes. In addition, the invention preferably uses a geocomposite in which all the sheets are textile, which offers good flexibility owing to the fact that it is made of fiber and/or wire. This textile forms the support for the conductive components forming the electrodes in the system. In addition, in certain preferred embodiments, this textile also forms the support for the mini-drains that improve the evacuation of the waters. This type of textile geocomposite makes it possible to provide for large dimensions (large two-dimensional expanse), notably owing to easier manufacturing, for example by needling as described in the patent applications WO 2006/030076, WO2011015736 or WO2012/080659. In addition to ease of manufacturing and handling, the flexibility offers the option of delivering the geocomposite in rolls that can be unrolled on site. Finally, the textile provides a filtering function (separating the solid from the liquid) in addition to the draining function.

Various embodiments of the invention also have the advantage of providing a particularly effective, viable and reliable support for electrokinetic phenomena. In certain of these embodiments, use is made of at least one electrode comprising carbon, preferably in the form of carbon fibers. Carbon, preferably used pure or at least at percentages greater than 20%, and arranged in the form of fibers, will preferably be structured to form wires incorporated into the geocomposite. Notably, carbon has never been used at such percentages and/or in this form to apply an electric field in this type of application. However, the inventors of the present application have discovered that it is effective enough to conduct the electricity required for electrokinetic phenomena and offers the additional advantage of being particularly resistant to corrosion. Thus, even if it conducts less electricity than a metal, it makes it possible to fulfill its function of conductor, but also makes it possible to obtain volumes of evacuated water that are clearly greater than those obtained with metals since it offers better longevity and better reliability over time. In addition, the term “containing carbon” is used here to stress the fact that the electrode can of course be made of carbon, but that it can also contain other materials, and that it is the presence of carbon that is generally found to be sufficient, particularly when it is present in the form of fibers (preferably structured into wires) and/or on the basis of a percentage greater than 20%. Nonetheless, an electrode containing pure carbon fibers will preferably be chosen, to completely fulfill the functions described here. In the present description “made of carbon” denotes the fact that the electrode contains carbon (whether or not it is completely made of carbon) and “carbon fibers” denotes the fact that the electrode contains carbon fibers, whether the latter are made of 100% carbon (preferably) or less. Thus, the expression “made of carbon” of course covers the expression “carbon fibers”. In certain embodiments, particularly where electrodes are incorporated into the geocomposite, said carbon of said electrodes (11, 12) is in the form of carbon fibers. The composition of these fibers makes them particularly resistant to corrosion and conductive enough to be used in the present invention. These carbon fibers have the advantage of being easy to handle, particularly over great lengths, which makes them easier to incorporate into the geocomposite. In addition, these fibers can be delivered in the form of wires of variable diameters and lengths, facilitating their incorporation into the geocomposite. Thus, in certain embodiments, the carbon fibers are sewn or needled over at least one sheet (21, 22) of the geocomposite (2). In certain embodiments, the fibers are simply interposed between two sheets of the geocomposite and the assembly of the sheets, for example by needling as detailed in the present application, allowing the immobilization of the carbon fibers in the geocomposite, as detailed below.

Moreover, it is in the part that comes into contact with the mud or tailings that the carbon is important. Thus, according to various embodiments, the electrode(s), at least a part of which contains carbon is (are) linked to at least one metal part to improve the distribution of the current from the generator (10) over long distances. Indeed, it is generally preferable to conduct the current by metal over the long distances that known treatment basins (B) cover, and to take advantage of the carbon for the distribution of the current to the soil to be treated. On the other hand, as the metal is very easily corroded in such basins, it will preferably be insulated over its whole path up to the carbon parts. In addition, in certain embodiments, it is generally preferred that said metal parts and their connections to the carbon parts are provided with means (13) for protecting from corrosion. A protective box (protecting from short circuits, but also corrosion) can therefore be used. Thus, in certain embodiments, the means (13) for protecting against corrosion include watertight insulation means. Nonetheless, such protection means (13) can simply consist of the fact that the metal distribution network and/or the connections is (are) outside the mud or tailings. Any device emerging from the mud would thus form such protection means (13). However, in order for the carbon to be reserved for the parts actually in contact with the mud, watertight protection devices are preferred, such as those illustrated in FIGS. 1 and 2.

As mentioned in the introduction to the present application for the example of clay soils, the water moves from the anode to the cathode under a DC electric field. Advantage is therefore taken of this phenomenon by arranging at least one of the electrodes in or on the geocomposite so that the water thus moved is more easily drained and evacuated. It is therefore generally preferable that it is at least the cathode that is incorporated into the geocomposite (“incorporated into” here meaning incorporated above or inside) since it attracts water. Additionally, the anode is the electrode that corrodes rapidly because of the acidification and electrolysis. It is therefore generally preferable that it is at least the anode that contains carbon. Thus, in certain embodiments, as represented in FIG. 1 for example, the system can include at least one electrode (12), preferably the cathode, incorporated into the geocomposite (2) connected to the evacuation device (20) and at least one electrode (11), preferably the anode, arranged outside the geocomposite, such as for example on a boat, such as on a floating barge for example. The anode (11) can then be moved quickly, particularly to palliate the problem of the dewatering of the anode area, and it can be changed easily to palliate the problem of its corrosion. In addition, the anode preferably contains carbon to optimize its lifetime, whereas the cathode can in this case be metallic (without carbon.) Those skilled in the art will understand that the reverse configuration remains within the scope of the invention because the carbon anode would fully serve its purpose by being incorporated into the geocomposite (as it is not easily interchangeable, it is advantageous that it resists well to corrosion.) However, this reverse configuration is not preferable, because a cathode outside the geocomposite would have to be associated with a specific evacuation device (20) (optionally additional to that connected to the geocomposite) and would not be very effective, particularly on a boat. In addition, the dewatering of the anode area would not be combated and the draining properties of the geocomposite would not be exploited as well as if the latter incorporated the cathode. Finally, the configurations actually preferred, in general, are those wherein it is the two electrodes (11, 12) that include at least one carbon part. This is because, in this configuration, the two electrodes can play the part of cathode and anode in turn, and greater advantage can be derived from each of the two configurations detailed above. In addition, with two electrodes (11, 12) made of carbon, it is possible to take full advantage of the preferred embodiments of the present invention, for example of the type represented in FIG. 2. These preferred embodiments rely on the fact that the two electrodes are incorporated into the geocomposites. Thus, the two electrodes are disposed in contact with the mud. It is then preferable that these two electrodes be made of carbon to derive full advantage therefrom, owing to the fact that the polarity of the electrodes can then be reversed, for example by switching means (14), for example provided in the generator (10) or in addition to the latter. By reversing the polarity, the dewatering of the anode area is limited and corrosion is slowed down by distributing it more evenly over the two electrodes alternately. Thus the use of these preferred embodiments is detailed in the present application with reference to the method of consolidation.

In certain of these preferred embodiments, the two electrodes (11, 12) have at least a part incorporated into or on separate strips of geocomposite (2) arranged apart from one another within the soil to be treated. Two strips arranged at a determined distance (depending on the nature of the soil and the current or voltage to be applied, the conductivity, etc.) will thus each be connected to a pole of the generator so that they act as the anode-cathode pair and dewater the soil contained between their surfaces. In these embodiments, installation is made easier and it is possible to greatly increase the pairs of geocomposites to improve the conduction of electricity over the whole site (particularly with materials more conductive than carbon, as mentioned above.)

Geocomposite

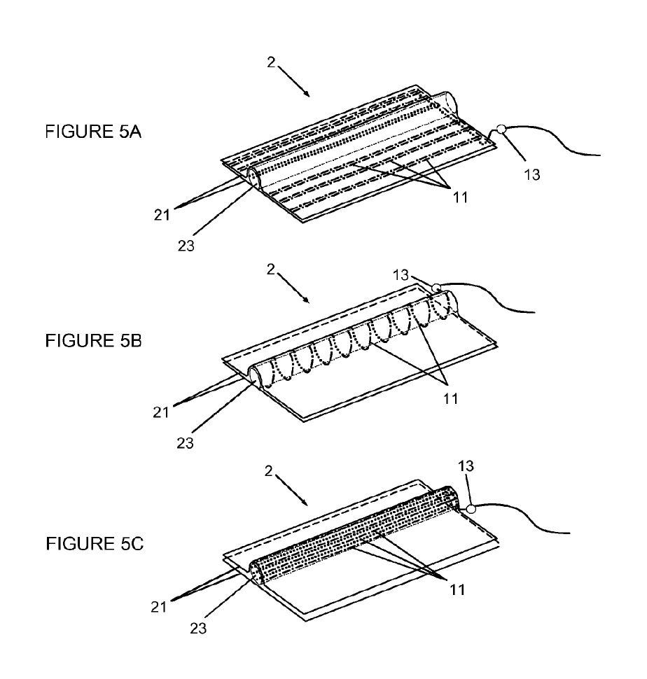

The present invention therefore also relates to a geocomposite (2) for soil treatment, particularly for use in a system according to the invention. This geocomposite incorporates at least a part of at least one of the electrodes (11, 12) of the system and it comprises at least one filtering sheet (21) and/or at least one draining sheet (22). In certain embodiments, at least a part of at least one of said electrodes (11, 12) of the system contains carbon. In addition, it is generally preferable that it is the electrode incorporated into the geocomposite that contains carbon. However, in certain embodiments, the electrodes used can be all made of metal or another sufficiently conductive material, particularly chosen from the materials known to the prior art, such as for example copper or graphite or even certain plastics. On the other hand, electrodes containing carbon are sometimes more resistant to corrosion, particularly when they include carbon fibers. Indeed, certain electrodes containing carbon are unstable, such as for example electrodes comprising carbon black (combustion residue), for example incorporated into resins (made of polyethylene for example), because of the very structure of the material and/or its manufacturing, whereas electrodes made of carbon fibers are very resistant to corrosion and will therefore be preferably used in the present invention. In certain embodiments, in particular in the case of electrodes made of another material than carbon fibers, provision will preferably be made for facilitation of replacement of the electrodes, or even to the geocomposites, since longevity can be shorter, unless another material as resistant to corrosion as carbon fibers is used. Replacement can for example be facilitated by incorporating the electrodes into mini-drains of the geocomposite, as in certain embodiments detailed hereinafter. Specifically, by making provision for access to these mini-drains and to the electrodes that they contain, it is possible to envision removing the eroded electrodes and introducing new ones, using a guide (preferably rigid or semi-rigid) to be introduced into the mini-drains or using a guide (preferably non-corrodible, but flexible or rigid) already in place in the mini-drains. In certain preferred embodiments (that which is preferred for the geocomposite also being generally so for the system and the method), perforated mini-drains (23) are incorporated into said geocomposite (2). These mini-drains facilitate the evacuation of the water, whether it takes place through a passive device (e.g. outlet) or an active device (e.g. pumping) as detailed above. Specifically, it is easy to link these mini-drains (23) to evacuation pipes (3), as for example represented in FIGS. 1 and 2, and the water then leaves the basin easily owing to such geocomposites, which are particularly effective and optimized by the electrokinetic phenomena. As the electrodes are preferably disposed within the mud to improve dewatering, it is preferable to dispose them as close as possible to the water evacuation means (pipes linked to the evacuation device) and it is therefore preferable to dispose them close to the mini-drains (23). Thus, in certain embodiments, at least a part of at least one of said electrodes (11, 12) is arranged substantially parallel to the mini-drains (23), as for example represented in FIGS. 5A and 5C. In the illustrative and non-limiting example of FIG. 5A, the electrodes are arranged between two sheets of the geocomposite, along a path substantially parallel to the mini-drains (23). The attachment of the electrodes (11, 12), which is not indispensable according to the case, can be done by sewing or needling or simply by assembling the sheets of the geocomposite or any appropriate means, as discussed above with reference to carbon fibers. In the illustrative and non-limiting example of FIG. 5C, the electrodes are disposed along the mini-drains (23) and therefore follow a path parallel to the mini-drains. In this example, an attachment can be provided for example over the portion of the sheets that is intended to surround the mini-drains (23). In the illustrative and non-limiting example of FIG. 5B, the electrodes (11, 12) are wound around the mini-drains (23) of the geocomposite (2) and therefore follow a path substantially parallel to the mini-drains. In this example, the attachment is even less necessary, particularly if there are grooves on the mini-drains, as explained hereinafter. In other embodiments, a combination of these various dispositions of electrodes parallel to the mini-drains may be used, such as for example inside and/or along and/or around the mini-drains. In certain embodiments, the electrodes can optionally be disposed inside the mini-drains, but it is generally preferable to dispose them outside the mini-drains, or even outside the sheets (therefore on the sheets but not between two sheets) so that the electrodes are in as much contact as possible with the liquid. This is because the electrode is only effective if it is in direct contact with the liquid and it is all the more effective if the liquid is rich in water. In particular, as the mud generally becomes dewatered around the anode, it is preferable that the latter not be surrounded with structures that run the risk of limiting the water flow (such as, for example, the filtering sheets or mini-drains or other.) Thus, even if it is desirable to have a path of at least one of the electrodes that is substantially parallel to the mini-drains, it is generally preferable not to incorporate it into the latter. In the various possible embodiments of the invention, provision will generally be made for an electrode output through or over the edges of the geocomposite, for the connection to the generator, directly or via other conductive wires and optionally via the protection means (13) as already explained here. Said mini-drains (23) are preferably mutually parallel. Without being limiting, the mini-drains (23) can be distributed such that they are spaced apart by a distance ranging from 0.2 meters to 4 meters in width of the geocomposite (2), preferably between 0.5 and 2 meters, ideally in the order of the meter. These embodiments with the electrodes parallel to the mini-drains are particularly advantageous in terms of electrokinetic effectiveness, whatever the material used for the electrodes (carbon or not), because the electrodes attract the water as near as possible to the mini-drains that form the main draining (pumping) source in these embodiments. Nonetheless, it is generally preferable to use a combination of these embodiments, by using electrodes made of carbon, preferably carbon fibers, arranged in a path substantially parallel to the mini-drains incorporated into the geocomposite, because the conduction of the carbon is clearly adequate, in particular if mini-drains are used for the pumping. Nonetheless, depending on the applications (particularly the dimensions), electrokinetic phenomena are to be considered at the macroscopic level and it is in fact enough that the electrodes are located in the same average plane as the geocomposite (“average” meaning that the plane is not necessarily flat and that slight variations are possible, but also that the electrodes can in fact be disposed at a short distance from the sheets of the geocomposite even if one prefers not to do so for practical reasons of installation of the system and/or manufacturing.) Thus, even if the electrodes (made of carbon or not) are in fact not parallel to the mini-drains (for example perpendicular or diagonal), good results can sometimes still be obtained, as long as the electrodes are close enough to the mini-drains for the water attracted by these electrodes to be evacuated by these mini-drains, in particular if the distribution of the electrodes is adapted to the nature of the geocomposite. However, an arrangement of the electrodes parallel to the mini-drains often remains advantageous because, even if the geocomposite can play most of its part in its average plane, particularly by transferring the weight of the mud below it, the electrodes still play a part in attracting the water and the fact of disposing them close to the mini-drains generally offers an advantage for the flow of the water in the mud and the evacuation of the water through the mini-drains.

In certain embodiments, the mini-drains (23) are perforated. In certain of these embodiments, they have perforations which instead of being round are oval or oblong to limit resistance to the entry of fluid and thus to limit clogging of the perforations. Illustratively and without being limiting, these perforations can have a size in the order of 0.5 millimeters to 2 millimeters, preferably from 0.7 to 1.5 mm, ideally in the order of the millimeter. In addition, in certain embodiments, the mini-drains are annealed to provide better resistance to stress, which allows them to be buried under a considerable quantity of soil (S). The aim of the mini-drains (23) is to capture the fluid (F) for the purpose of evacuating it. Illustratively and without being limiting, they are in general resistant to stresses of up to 750 kPa which corresponds to approximately 50 m of soil (S) height in average above the mini-drain. The mini-drains (23) are resistant to compression which allows the fluids to also be able to be evacuated even when the geocomposite (2) is buried. According to various embodiments, without being limiting, in order to optimize the flow of the fluid, the mini-drains (23) can have diameters between 5 mm and 50 mm, preferably between 10 mm and 25 mm, ideally in the order of 25 mm. The diameters will be naturally adapted according to the soil to be treated. Nonetheless, the diameter of the mini-drains must not exceed a certain value for a given composition and arrangement of the mini-drains, such that they resist stress as mentioned above.

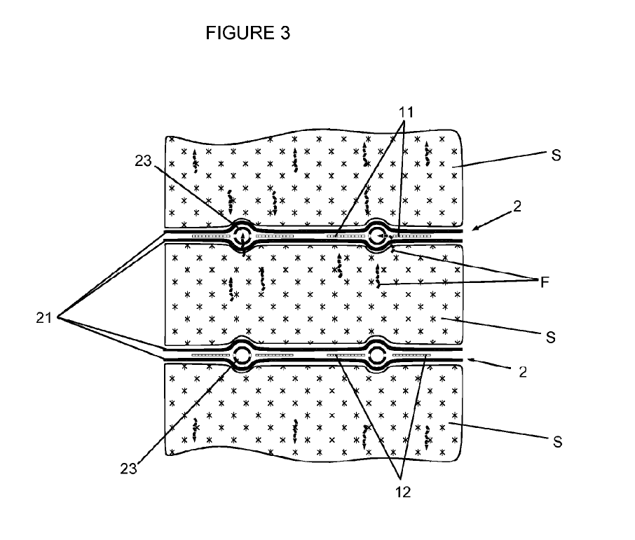

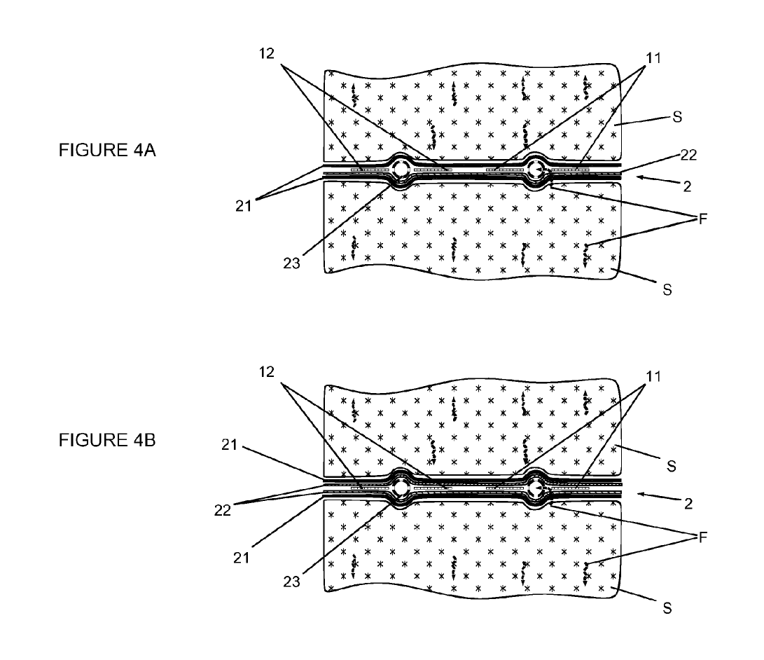

As mentioned previously, the geocomposite preferably includes textile sheets, such as for example those described in the patent applications WO 2006/030076, WO2011015736 or WO2012/080659. As the filtering function is advantageous in the system, provision is preferably made for at least one filtering sheet (21). It is possible to provide only draining sheets (22), but this solution is not preferable as the draining sheets tend to poorly withstand direct contact with mud. Thus, it is generally preferable to insulate any draining sheet (22) from the mud by covering it with a filtering sheet (21). The aim of the filtering sheets (21) is then to protect the draining sheet (22) from clogging by fine particles. Such sheets consequently have a pore size suitable for this function, in the same way as the draining sheet has a pore size suitable for its function. It is possible to use one filtering sheet and one draining sheet only, but it is preferable to use (at least) two filtering sheets, for example as represented illustratively and without being limiting in FIG. 3, where two filtering sheets are disposed on either side of the electrodes and the mini-drains. It is also possible to make provision for a draining sheet inside, as for example represented in FIG. 4A, or else two draining sheets inside, as for example represented in FIG. 4B. The use of at least one draining sheet will be envisioned according to the particular applications of this invention, particularly the nature of the ground, the mud etc, but their use is generally to be avoided for reasons of excessive costs and inferior ease of handling.

Moreover, it is possible to choose different filtration apertures between the two sheets (upper and lower) to facilitate the evacuation of the water (F) as a function of the electrokinetic phenomena, the nature of the soil to be filtered and the boundary conditions.

Note that we refer here to a “sheet” which is a conventional term for a geotextile, generally corresponding to an entanglement of needled wires which can also be denoted by the term “felt”, but it is possible to use other types of coating, preferably geotextiles, such as for example woven or non woven textiles, knit or non-knit textiles, etc. This term “sheet” conventionally denoting a type of textile must thus be interpreted in a less limiting manner in the present application because it is planned to use other types of coating than the geotextile sheets, although the latter are particularly suitable for the present invention. Indeed, entanglements of needled wires generally provide permeability that is particularly suitable for the present invention.

Method

The present invention also relates to a soil consolidation method.

This method preferably includes at least the following steps (each step being able to contain several steps and/or be implemented in a single step or be implemented in successive complementary actions):
laying (51) of at least one geocomposite (2) according to claim 14 in said basin (B);
connection (54) of the geocomposite (2) to the evacuation device (20);
connection (55) of said at least one electrode (11, 12) of the geocomposite (2) to said electric generator (10);
pouring (56) of mud or tailings on the geocomposite (2);
connection (55) of the other electrode (12, 11) to said electric generator (10).

The connection (54) can include a laying (541) of evacuation pipes (3), particularly if provision is not made for them in the basin (B). This connection (54) can also include the connection of the mini-drains to the evacuation pipes (3), when the geocomposite includes these mini-drains (23). This connection (54) can also include the connection of the evacuation pipes (3) to the evacuation device (20) or simply the connection of the geocomposite(s) (2) to the evacuation device (for example by any appropriate device for connecting the geotextile (sheet) to the evacuation).

The connection (55) to the generator (10) includes a connection (551) of the electrodes (11, 12) to the generator (at least one electrode at a time, i.e. one polarity at a time.) In certain embodiments, this connection, particularly for the second electrode which is incorporated into a geocomposite, requires beforehand the laying (51) of a second geocomposite (2) according to the invention in said basin (B). The connection (55) of the “other electrode” (12, 11) to said electric generator (10) corresponds to the connection of the “electrode of this second geocomposite (2)”. These steps of connection (55) to the generator (10) can also include a connection (552) in the protection device (13), for putting the carbon part in contact with the metallic part. These connections (55) to the generator (10) can also include connection (553) to the switching means (14), when provision is made for the latter. In this case, the method can include a reversal (57) of polarity, preferably after a time period determined beforehand as a function of the dewatering speed of the anode area and/or as a function of the lysis of the anode, so as to optimize the effectiveness and/or lifetime of the system. Indeed, reversing the polarity at an appropriate time makes it possible to avoid excessive dewatering of the anode area and also makes it possible to rehydrate it, which makes it possible to combat the increase in resistivity of said anode area. Moreover, the corrosion of the anode is limited. The method can therefore include a series of reversals of polarity, determined to optimize the dewatering of the mud or tailings.

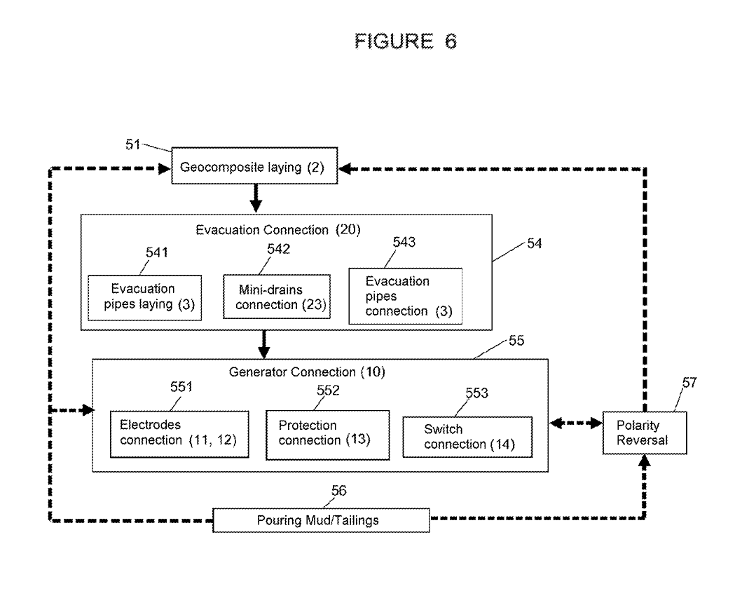

Moreover, it is known that mechanical stress exerted on the mud or tailings leads to expulsion of the interstitial fluid. In certain embodiments, the system will allow the fluid to be pressurized by adding at least one new layer of mud, generating stresses on the underlying sheets, thus allowing the fluid to be evacuated and to accompany the consolidation of the bulk in the basin. Thus, the method, by the repeated implementation of at least some of these steps, as illustrated by the dotted lines in FIG. 6, makes it possible to add successive layers of mud or tailings on top of the geocomposites and to thus obtain enough stress on the lower levels to optimize the evacuation of the water. The introduction of the present application moreover explains these phenomena (cf. drainage horizons) which promote evacuation when such an increase in stress occurs, particularly when geocomposites are disposed in the basin (B).

Moreover, the present invention can also relate to methods of fabrication for manufacturing a geocomposite for soil consolidation. Indeed, the geocomposites according to various embodiments described in the present application are particularly advantageous due to the fact that they include electrodes substantially parallel to mini-drains, and/or they include electrodes comprising carbon, particularly carbon fibers. Thus, in certain embodiments, the present invention relates to a method for manufacturing a geocomposite for soil consolidation, wherein mini-drains, preferably mutually parallel, are disposed on a first sheet (filtering and/or draining), and electrodes substantially parallel to these mini-drains, then at least one second sheet (filtering and/or draining), on top of the first sheet, the electrodes and the mini-drains. Preferably, the sheets are then assembled by needling, in a manner known per se, for example as described in page 5, line 3, to page 7 line 3 of the patent application WO2006/030076. In certain embodiments, the method includes a step of winding the electrodes around the mini-drains before they are disposed on the first sheet. In certain embodiments, the method includes a step of threading the electrodes through the mini-drains. In certain embodiments, the method includes a step of disposing the electrodes along the mini-drains. In certain of these embodiments, the method includes a step of preparing the electrodes by incorporating carbon into the electrodes, preferably in the form of wires based on carbon fibers. Moreover, in certain embodiments, the present invention concerns a method for manufacturing a geocomposite for soil consolidation, wherein electrodes containing carbon are disposed on a first sheet (filtering and/or draining), then at least one second sheet (filtering and/or draining) on top of the first sheet. In certain of these embodiments, the method includes a step of preparing the electrodes in the form of wires based on carbon fibers. The sheets are preferably assembled together, as detailed above. For the two types of manufacturing methods described above, the preparation of the carbon fiber electrodes can include weaving or assembling of the carbon fibers to obtain woven or nonwoven strips to be incorporated into the geocomposite.

Note that we refer here to needling of the sheets, but there are other methods, such as knitting or weaving. Thus, various embodiments of the two types of manufacturing method described above include a step of assembling the sheets and/or electrodes (made of carbon fibers or otherwise) by knitting or weaving. These assembly methods moreover facilitate the implantation of electrodes not parallel to the mini-drains, whereas needling is particularly advantageous for the arrangement of the electrodes parallel to the mini-drains, since it is less complex and expensive.

The present application describes various technical features and advantages with reference to the figures and/or various embodiments. Those skilled in the art will understand that the technical features of a given embodiment can in fact be combined with features of another embodiment unless explicitly stated otherwise, or unless the combination does not provide a solution to at least one of the technical problems mentioned in the present to application. In addition, the technical features described in a given embodiment can be isolated from the other technical features of this embodiment unless explicitly stated otherwise.

It must be obvious to those skilled in the art that the present invention allows embodiments in many specific forms without departing from the field of application of the invention as claimed. Consequently, the present embodiments must be considered as illustrations, but can be modified in the area defined by the scope of the appended claims, and the invention must not be limited to the details given above.

1. A soil treatment system comprising: at least one electric generator and at least two electrodes and at least one evacuation device, wherein:
the system includes at least one geocomposite that incorporates at least a part of at least one of said electrodes and which comprises at least one filtering sheet and/or at least one draining sheet,
perforated mini-drains are incorporated into said geocomposite, at least a part of at least one of said electrodes is disposed along a path substantially parallel to the mini-drains.

2. The system according to claim 1, wherein at least a part of the two electrodes contains carbon.

3. The system according to claim 2, wherein at least a part of at least one of said electrodes contains carbon, in the form of carbon fibers.

4. The system according to claim 1, wherein only one of the two electrodes has at least a part containing carbon whereas the other is metallic.

5. The system according to claim 1, wherein the electrodes are disposed substantially parallel to the mini-drains.

6. The system according to claim 1, wherein the electrodes are wound around the mini-drains of the geocomposite.

7. The system according to claim 1, wherein said carbon fibers of said electrodes are arranged in the form of wires.

8. The system according to claim 7, wherein the carbon wires are sewn onto at least one sheet of the geocomposite.

9. The system according to claim 1, wherein the two electrodes have at least a part incorporated into or onto separate strips of geocomposite disposed at a distance from one another within the soil to be treated.

10. The system according to claim 1, wherein the system includes switching means to reverse the polarity of the electrodes.

11. The system according to claim 1, wherein said electrodes, at least a part of which contains carbon fibers, are connected to at least one part made of metal to improve the distribution of current of the generator over long distances.

12. The system according to claim 11, wherein said metal parts and their connections with the carbon parts are equipped with means for protecting from corrosion.

13. The system according to claim 12, wherein the means for protecting from corrosion include watertight insulation means.

14. A soil treatment geocomposite, wherein the geocomposite is arranged for use in a system according to claim 3, at least by the fact that the geocomposite incorporates at least a part of at least one of the electrodes of the system and that the geocomposite comprises at least one filtering sheet and/or at least one draining sheet, at least a part of at least one of said electrodes containing carbon in the form of carbon fibers.

15. A soil treatment geocomposite, wherein the geocomposite is arranged for use in a system according to claim 1, at least by the fact that the geocomposite comprises at least one filtering sheet and/or at least one draining sheet, with incorporated perforated mini-drains, and that the geocomposite incorporates at least a part of at least one of the electrodes of the system, disposed along a path substantially parallel to the mini-drains.

16. A method for consolidating soil, particularly mud or tailings, by the use of a system according to claim 1, in a consolidation basin, the method being wherein the method includes:
laying of at least one geocomposite wherein the geocomposite incorporates at least a part of at least one of the electrodes of the system and that the geocomposite comprises at least one filtering sheet and/or at least one draining sheet, at least a part of at least one of said electrodes containing carbon in the form of carbon fibers in said basin;
connection of the geocomposite to the evacuation device;
connection of said at least one electrode of the geocomposite to said electric generator;
pouring of mud or tailings onto the geocomposite;
connection of the other electrode to said electric generator.

17. The method according to claim 16, wherein the method includes the laying of a second geocomposite wherein the second geocomposite incorporates at least a part of at least one of the electrodes of the system and that the second geocomposite comprises at least one filtering sheet and/or at least one draining sheet, at least a part of at least one of said electrodes containing carbon in the form of carbon fibers, in said basin, and in that the connection of the other electrode to said electric generator corresponds to a connection of the electrode of this second geocomposite.

18. The method according to claim 17, wherein the method includes a reversal of the polarity of the electrodes, using switching means, this reversal of polarity being implemented at the end of a determined period, to optimize the lifetime and/or effectiveness of the system.
